(19) United States
(12) Patent Application Publication
(10) Pub. No.: US 2023/0251234 A1
(43) Pub. Date: Aug. 10, 2023

(54) AMINO ACID ANALYSIS METHOD AND LIQUID CHROMATOGRAPHIC APPARATUS

(71) Applicant: HITACHI HIGH-TECH SCIENCE CORPORATION, Tokyo (JP)

(72) Inventors: Masahito ITO, Tokyo (JP); Norimasa MINAMOTO, Tokyo (JP); Yusuke HOSEN, Tokyo (JP); Masami SHIBUKAWA, Saitama City (JP)

(21) Appl. No.: 18/058,698

(22) Filed: Nov. 23, 2022

(30) Foreign Application Priority Data
Feb. 8, 2022 (JP) 2022-018006

(51) Int. Cl. G01N 30/96; G01N 30/54

(52) U.S. Cl. CPC G01N 30/96; G01N 30/54; G01N 2030/3076

(57) ABSTRACT

Disclosed herein are an amino acid analysis method and a liquid chromatographic apparatus for improving separation performance of threonine, serine, glycine, and alanine. The method of analyzing amino acids using the liquid chromatographic apparatus equipped with a cation exchange column includes a process for distributing a sample containing threonine, serine, glycine, and alanine as the amino acids, together with an eluent, to the cation exchange column to separate threonine, serine, glycine, and alanine, wherein a column temperature when separating threonine and serine is higher than a column temperature when separating glycine and alanine.

### CROSS-REFERENCE TO RELATED APPLICATION

This application claims priority to Japanese Patent Application No. 2022-018006, filed on Feb. 8, 2022, which is incorporated herein by reference in its entirety.

### BACKGROUND

### Technical Field

The present disclosure relates to an amino acid analysis method and a liquid chromatographic apparatus.

### Description of Related Art

Liquid chromatography is known as a method for analyzing sample components in a sample. The liquid chromatography generally improves separation performance by raising the temperature of a separation column during the separation process of sample components by the separation column.

For example, Patent Document 1 discloses that a sample containing multiple types of amino acids is distributed to a separation column heated by a temperature gradient including a temperature range of 100° C. or higher to separate and analyze the amino acids in the sample in a shorter time with high accuracy.

### PATENT DOCUMENT

Patent Document 1: Japanese Patent No. 6595086

Incidentally, the prior art, such as Patent Document 1, does not disclose an improvement in separation performance focusing on amino acid components, especially threonine, serine, glycine, and alanine, which have short retention times and are eluted at the early stage of analysis.

### SUMMARY

Accordingly, an object of the present disclosure is to improve separation performance of threonine, serine, glycine, and alanine in an amino acid analysis method and a liquid chromatographic apparatus.

In accordance with an aspect of the present disclosure, there is provided a method of analyzing amino acids using a liquid chromatographic apparatus equipped with a cation exchange column, which includes a process for distributing a sample containing threonine, serine, glycine, and alanine as the amino acids, together with an eluent, to the cation exchange column to separate the threonine, serine, glycine, and alanine, wherein column temperature when separating threonine and serine is higher than column temperature when separating glycine and alanine.

In accordance with another aspect of the present disclosure, there is provided a liquid chromatographic apparatus that includes a liquid sending unit configured to send an eluent to a flow path, a sample injection unit provided downstream of the liquid sending unit to inject a sample containing threonine, serine, glycine, and alanine into the eluent in the flow path, a cation exchange column provided downstream of the sample injection unit to separate sample components in the sample, a temperature regulating means for regulating a column temperature of the cation exchange column, and a control means for controlling the temperature regulating means, wherein the control means controls the temperature regulating means such that the column temperature when separating threonine and serine is higher than the column temperature when separating glycine and alanine.

According to the present disclosure, it is possible to improve separation performance of threonine, serine, glycine, and alanine in the amino acid analysis method and the liquid chromatographic apparatus.

### BRIEF DESCRIPTION OF THE DRAWINGS

FIG. 1 is a schematic diagram illustrating a device configuration and a flow path of an amino acid analyzer 100 in Example 1.

FIG. 2 is a schematic diagram illustrating a timetable on a time program that controls an operation of the amino acid analyzer 100 in Example 1.

FIG. 3 illustrates a chromatogram of Example 1.

FIG. 4 is a schematic diagram illustrating a timetable on a time program that controls an operation of an amino acid analyzer 100 in Example 2.

FIG. 5 illustrates a chromatogram of Example 2.

FIG. 6 illustrates a chromatogram of Example 3.

FIG. 7 illustrates a chromatogram of Comparative Example 1.

FIG. 8 illustrates a chromatogram of Comparative Example 2.

### DESCRIPTION OF SPECIFIC EMBODIMENTS

Hereinafter, embodiments of the present disclosure will be described in detail with reference to the drawings. The following description of preferred embodiments is merely exemplary in nature and is not intended to limit the disclosure, its applicability, or its use.

<Liquid Chromatographic Apparatus>

A liquid chromatographic apparatus serves to separate target components of a sample with a separation column while sending a mobile phase (eluent) and to detect the components flowing in separated order with a detector such as a spectrophotometer in order to analyze the components of the sample. Examples of the liquid chromatographic apparatus according to the present disclosure include a high performance liquid chromatograph (HPLC), an ultra high performance liquid chromatograph (UHPLC), and the like. Preferably, the liquid chromatographic apparatus is, but not limited to, an HPLC.

The separation mode of the liquid chromatographic apparatus according to the present disclosure is an ion exchange mode for separating ionic components or the like in the sample. Ion exchange chromatography serves to separate and analyze sample components with different properties by utilizing interactions that occur between the sample components in two phases which are a stationary phase consisting of an ion exchanger such as an ion exchange resin and a mobile phase consisting of a buffer solution or the like. In general, an ion exchanger includes a cation exchanger, such as sulfonic acid or carboxylic acid, and an anion exchanger, such as quaternary ammonium or tertiary ammonium, depending on the properties of chemically modified ion exchange groups. The ion exchanger of the liquid chromatographic apparatus according to the present disclosure is a cation exchanger, and in this specification, the column packed with a cation exchanger as a stationary phase is referred to as a cation exchange column or simply a separation column.

The liquid chromatographic apparatus according to the present disclosure is an apparatus for analyzing a sample containing amino acids, particularly a sample containing at least threonine, serine, glycine, and alanine as components to be separated. Specifically, examples of the liquid chromatographic apparatus according to the present disclosure includes an amino acid analyzer used for analysis of amino acid composition of proteins and peptides, analysis of amino acids and related substances in pharmaceuticals, biological fluids, etc., an HPLC system used for analysis of proteins, amines, organic acids, etc., and the like. Preferably, the liquid chromatographic apparatus is an amino acid analyzer.

The sample to be analyzed by the liquid chromatographic apparatus according to the present disclosure contains at least threonine, serine, glycine, and alanine, and may contain other amino acids, and so on. For example, in the simultaneous analysis of various types of amino acids, the amino acids and amino acid-related substances to be analyzed may be roughly classified into about 20 types of protein hydrolyzate amino acids and 40 or more types of biological fluid amino acids and amino acid-related substances. These various types of amino acids may be simultaneously analyzed by mixing a plurality of buffer solutions, adding a sample to the mixed buffer solution, and passing through a separation column for detection.

The liquid chromatographic apparatus according to the present disclosure may be an apparatus for analyzing sample components by a gradient elution method. In this case, multiple types of eluents are used as mobile phases for separation. The term “gradient” herein is used as a term including a stepwise gradient, a curved gradient, and a linear gradient.

The liquid chromatographic apparatus according to the present disclosure includes, for example, a liquid sending unit, a sample injection unit, a separating unit, and a detector in order from the upstream side of the flow path, and includes a controller connected to each unit to control the operation thereof. The liquid chromatographic apparatus may have any other components in addition to these components. Specifically, for example, in order to facilitate detection of sample components, it may include devices such as a reagent, a pump, a mixer, and a cartridge-type reactor for pre-column derivatization or post-column derivatization.

[Liquid Sending Unit]

The liquid sending unit sends a mobile phase to a flow path. In detail, the liquid sending unit sends at least a single eluent as the mobile phase for separation. In particular, when the gradient elution method is used, the liquid sending unit sends two or more types of eluents to the flow path. In addition, the liquid sending unit may be capable of sending, as the mobile phase, a mobile phase that is not used for sample separation, such as a column cleaning solution for cleaning the separation column or a regulating solution for adjusting the state of the separation column. Note that column cleaning is sometimes referred to as column regeneration, so the column cleaning solution as used herein is also referred to as a column regenerating solution.

Specifically, the liquid sending unit includes, for example, a container configured to store each mobile phase such as an eluent, a column cleaning solution, or a regulating solution therein, a solenoid valve configured to start/end sending the mobile phase in each container to the flow path or to regulate the flow rate of each liquid, a pump configured to send the mobile phase in each container to the flow path while regulating the flow velocity of each mobile phase, and so on. The solenoid valve may be provided corresponding to each container on the flow path provided corresponding to each container. The pump may be provided downstream of the solenoid valve on the flow path.

Specifically, for example, the flow paths corresponding to the respective containers may be merged downstream of the solenoid valve into one flow path, and one pump may be provided on that flow path (low-pressure gradient elution). In addition, the pump may consist of a plurality of pumps provided corresponding to the respective containers on the flow paths corresponding to the respective containers (high-pressure gradient elution).

The eluent may use, but not limited to, each liquid commonly used in the analysis of amino acids by liquid chromatography.

Specifically, for example, an aqueous solution and/or a buffer solution containing an alkali metal salt of a polybasic acid may be adopted as the eluent. Specifically, examples of the polybasic acid include inorganic polybasic acids such as sulfuric acid, selenic acid, phosphoric acid, and diphosphoric acid, and organic polybasic acids such as citric acid, sulfosalicylic acid, and fluorophthalic acid. Specifically, examples of the alkali metal include lithium, sodium, and potassium. It is preferable that the eluent contain at least one selected from the group consisting of a sodium citrate buffer solution, a lithium citrate buffer solution, and a sodium sulfate aqueous solution in order to improve the separation performance of amino acids.

The pH of the eluent may be, but not intended to be limited to, for example, between 2 and 5, preferably between 2.5 and 5. When the gradient elution method is used, it is preferable to gradually increase the pH of two or more types of eluents. The difference between the pH of the eluent that is sent first and the pH of the eluent that is sent next is preferably within 0.5, more preferably within 0.3.

In addition, the cation concentration, namely, the salt concentration contained in the eluent may be, but not limited to, for example, 0.05 N or more and less than 0.2 N, preferably between 0.12 N and 0.19 N. When the gradient elution method is used, it is preferable to gradually increase the salt concentration of the eluent.

In addition, the eluent may contain an organic solvent with the above-mentioned aqueous solution and/or buffer solution as a main component in order to improve the separation performance of amino acids. Specifically, examples of the organic solvent include ethanol, alcohol such as benzyl alcohol, acetonitrile, and so on.

The flow velocity of the eluent may be, but not limited to, a flow velocity commonly used in the liquid chromatographic apparatus. In order to accomplish speed up of analysis, the flow velocity of the eluent may be, for example, more than 0.40 mL/min, preferably between 0.50 mL/min and 2.0 mL/min.

The column cleaning solution may use, but not limited to, a liquid commonly used in the analysis of amino acids by liquid chromatography.

The regulating solution may use, but not limited to, each liquid commonly used in the liquid chromatography. Specifically, examples of the regulating solution may include a low-salt concentration aqueous solution, a low-pH aqueous solution, pure water such as distilled water, and so on. The salt concentration of the regulating solution is preferably lower than that of the eluent. In addition, it is more preferable to use pure water as the regulating solution in order to quickly transition the salt concentration of the separation column to its initial state. Moreover, when the low-pH aqueous solution is used as the regulating solution, the pH of the low-pH aqueous solution is preferably lower than the pH of the eluent.

[Sample Injection Unit]

The sample injection unit is a means that is provided downstream of the liquid sending unit in the flow path to inject the sample containing the above-mentioned four components into the mobile phase flowing through the flow path. Although the sample injection unit may be a hand-operated manual injector or an automatic autosampler, it is preferably an autosampler from the viewpoint of accurately controlling the injection timing and injection volume of the sample.

[Separation Unit]

The separation unit includes a separation column provided downstream of the sample injection unit in the flow path to separate the sample components in the sample, and a temperature regulator (temperature regulating means) provided in the separation column to regulate the temperature of the separation column (column temperature) during separation of the sample components by the separation column.

The separation column is not particularly limited as long as it is a column packed with the cation exchanger as the stationary phase as described above, and may use a column commonly used in the liquid chromatography.

The temperature regulator is not particularly limited as long as it is able to regulate the temperature of the separation column, and examples thereof include known devices such as a heater, a Peltier device, and a heat pump.

The temperature of the separation column may be specifically regulated, but not intended to be limited to, for example, between 20° C. and 150° C. In addition, the difference between the first temperature, which is a column temperature when separating threonine and serine, and the second temperature, which is a column temperature when separating glycine and alanine may be, but not intended to be limited to, for example, 10° C. or more.

[Detector]

The detector is a device provided downstream of the separation column in the flow path to detect sample components separated by the separation column. The detector may use, but not particularly limited to, a detector commonly used in the liquid chromatography, such as an electrical conductivity detector, an ultraviolet/visible absorptiometric detector, a fluorophotometric detector, or an electrochemical detector.

[Controller]

The controller is a device that controls at least the temperature regulator. The controller may be a device that controls each unit, such as the liquid sending unit or the sample injection unit, in addition to the temperature regulator.

Specifically, the controller is connected electrically in a wireless or wired manner to, for example, the solenoid valve and pump of the liquid sending unit, the sample injection unit in the case of the autosampler, the temperature regulator, etc., and sends control signals to them to control their operation. In addition, the controller is also connected electrically in a wireless or wired manner to, for example, the detector, etc., and acquires a result of detection of the detector to output the result as a chromatogram and data. The controller is, for example, a well-known microcomputer-based device, and includes an input section configured to input information from the outside, a storage section configured to store information, a calculation section configured to perform various arithmetic operations based on various types of information, and an output section such as a display section configured to output information.

The storage section of the controller stores a time program for executing an analysis process to be described later. The time program includes a timetable corresponding to each process included in the analysis process to be described later. When the gradient elution method is used, the time program includes a gradient elution time program for changing a mixing ratio of an eluent and sending the eluent to the liquid sending unit. That is, in the liquid chromatographic apparatus that performs analysis using the gradient elution method, the controller changes the mixing ratio of two or more types of eluents based on the gradient elution time program and sends the eluents to the liquid sending unit.

<Analysis Process of Liquid Chromatographic Apparatus>

The analysis process of the liquid chromatographic apparatus includes, for example, a sample injection process, a separation process, and a pre-injection liquid sending process. These processes are repeated as one method for the number of times set by the user. In addition, the analysis process may include, after the separation process and before the pre-injection liquid sending process, a cleaning process for sending the column cleaning solution to clean the separation column, a regulation process for sending the regulating solution to adjust the state of the separation column, and so on.

The sample injection process is a process for injecting the sample containing the above-mentioned four components into the eluent in the flow path by the sample injection unit. Although not intended to be limited, the time program may be created with the sample injection process as time zero.

The separation process is a process for separating the sample components, especially the above-mentioned four components, of the sample distributed together with the eluent in the separation column after the sample injection process. When the gradient elution method is used, at least in the separation process, the eluent is sent based on the gradient elution time program described above.

In the separation process, the temperature of the separation column is regulated by the temperature regulator in order to improve the separation performance of the separation column, as will be described later.

When the separation process is completed, for the next method, it is necessary to transition the state, such as temperature, salt concentration, or pH, of the separation column to the state before sample injection, namely, its initial state for stabilization. The pre-injection liquid sending process after the separation process is provided for that purpose. In the pre-injection liquid sending process, for example, the first eluent is sent to stabilize the separation column before the sample injection process of the next method.

<Amino Acid Analysis Method>

The amino acid analysis method according to the present disclosure is characterized by setting the column temperature (also referred to as “first temperature”) when separating threonine and serine (also referred to as “first group”) higher than the column temperature (also referred to as “second temperature”) when separating glycine and alanine (also referred to as “second group”).

That is, the control means controls the temperature regulating means by executing the time program configured such that the first temperature is higher than the second temperature.

When separating threonine, serine, glycine, and alanine using a cation exchange column, the retention time of the first group is shorter than the retention time of the second group, and the first group is eluted before the second group. Accordingly, for example, the control means may execute the time program configured to decrease the column temperature to elute the second group after the first group is eluted.

When the above four components are separated by the cation exchange column, these four components have short retention times and are eluted at the early stage of analysis, as described above. Accordingly, when the column temperature is increased constantly or gradually, it is difficult to clearly separate these four components. In detail, even if the second group is separated while maintaining the temperature at which the first group is separable, the peaks of glycine and alanine overlap, making it difficult to separate them clearly.

Here, the inventors of the present disclosure have made intensive studies and found that, when the above four components are separated by the cation exchange column, the first group is eluted before the second group, while the column temperature suitable for separation of the first group is higher than the column temperature suitable for separation of the second group. This is considered to be caused by the difference in response performance of the retention time of each component to the change in column temperature. That is, it is conceivable that the difference in retention time between threonine and serine increases at a higher column temperature, while the difference in retention time between glycine and alanine increases at a lower column temperature. Therefore, it is possible to improve the separation performance of the four components by setting the first temperature and the second temperature to column temperatures allowing for separating the first group and the second group, respectively, and decreasing the column temperatures to the second temperature to separate the second group after separating the first group at the first temperature.

When the eluent contains an organic solvent, it is preferable to allow the gradient elution to set the concentration of the organic solvent in the eluent when separating the first group to be higher than the concentration of the organic solvent in the eluent when separating the second group, for example. In other words, it is preferable to separate the second group by decreasing the concentration of the organic solvent in the eluent after separation of the first group. In this case, the control means may execute such a time program to further control the liquid sending unit. This further improves the separation performance of amino acids, especially the second group.

The concentration of the organic solvent in the eluent when separating the first group may be, but not intended to be limited to, for example, between 5% and 20%, preferably between 10% and 15%.

In addition, the concentration of the organic solvent in the eluent when separating the second group is not limited as long as it is lower than the concentration of the organic solvent in the eluent when separating the first group, and may be specifically, for example, less than 10%, preferably less than 5%.

### EXAMPLES

Hereinafter, an amino acid analyzer 100 (liquid chromatographic apparatus) and an amino acid analysis method according to Examples of the present disclosure will be described with reference to the drawings.

### Example 1

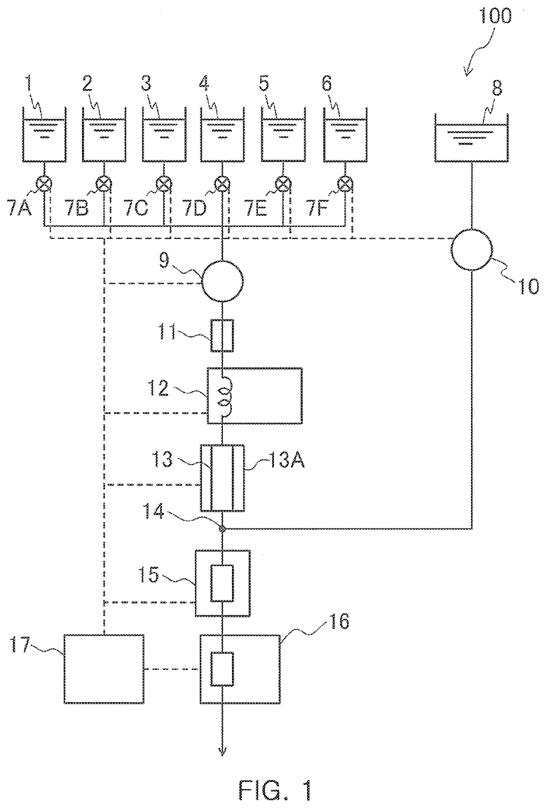

FIG. 1 is a schematic diagram illustrating a device configuration and a flow path of an amino acid analyzer 100 according to Example 1 of the present disclosure. The amino acid analyzer 100 is an ion exchange chromatographic system that utilizes a post-column derivatization method with ninhydrin.

The amino acid analyzer 100 may be equipped with first eluent 1 to fourth eluent 4 as mobile phases, distilled water 5 as a regulating solution, and column regenerating solutions 6 (also referred to as “B1 solution” to “B6 solution”, respectively). One of these liquids is selected by solenoid valves 7A to 7F and is sent by a mobile phase pump 9. The eluent is introduced into a separation column 13 after passing through an ammonia filter column 11. An autosampler 12 (sample injection unit) is provided downstream of the ammonia filter column 11 and upstream of the separation column 13, so that an amino acid sample is injected into the eluent in the flow path by the autosampler 12. The injected amino acid sample reaches the separation column 13 together with the eluent, and is separated by the separation column 13.

The amino acid analyzer 100 also includes a ninhydrin reagent 8 and a ninhydrin pump 10 for sending the ninhydrin reagent 8. Each amino acid component separated in the separation column 13 is mixed by a mixer 14 with the ninhydrin reagent 8 sent by the ninhydrin pump 10, and reacted in a heated reactor 15.

The amino acids (Ruhemann purple) colored by the reaction are continuously detected by a detector 16, and output as a chromatogram and data by a data processor 17 (controller) to be recorded and stored.

The separation column 13 is a sulfonic acid-based strong cation exchange column (filler base material: polystyrene resin, particle size: 3 μm).

The separation column 13 is provided with a temperature regulator 13A configured to regulate the temperature of the separation column 13, so as to freely increase or decrease the column temperature by heating or cooling. The container for each mobile phase, the reactor 15, or the like may also be provided with a temperature regulator (not shown) for controlling its temperature.

The detector 16 is a visible absorptiometric detector with a dominant wavelength of 570 nm, and is also able to detect 440 nm for proline or the like.

The data processor 17 controls the solenoids valves 7A to 7F of the respective containers storing the mobile phases of B1 solution to B6 solution, the mobile phase pump 9, the ninhydrin pump 10, the autosampler 12, the temperature regulator 13A, the temperature regulator (not shown) for regulating the temperature of the container for each mobile phase, the reactor 15, or the like, and so on. This control is mainly executed by a time program stored in the storage section (not shown) of the data processor 17.

In Example 1, a sample prepared by dissolving four components, such as threonine, serine, glycine, and alanine, in water was used as the amino acid sample. In the following description, the names and abbreviations of amino acids to be analyzed are shown in Table 1.

TABLE 1

| ABBREVIATION | AMINO ACID NAME |
|---|---|
| Thr | THREONINE |
| Ser | SERINE |
| Gly | GLYCINE |
| Ala | ALANINE |

A single first eluent 1 was used as the eluent. Table 2 shows the compositions of the first eluent 1 and the column regenerating solution 6. In Table 2, the salt concentration is shown as Na concentration.

TABLE 2
MOBILE PHASE COMPOSITION

| | | COLUMN |
|---|---|---|
| | FIRST | REGENERATING |
| NAME | ELUENT | SOLUTION |
| Na CONCENTRATION [N] | 0.16 | 0.2 |
| SODIUM CITRATE (2H₂O) [g] | 6.19 | — |
| SODIUM HYDROXIDE [g] | — | 8.00 |
| SODIUM CHLORIDE [g] | 5.66 | — |
| CITRIC ACID (H₂O) [g] | 19.80 | — |
| ETHANOL [mL] | 130.0 | 100.0 |
| BENZYL ALCOHOL [mL] | — | — |
| THIODYL GLYCOL[mL] | 5.0 | — |
| 25% BRIJ-35 [mL] | 4.0 | 4.0 |
| WHOLE AMOUNT [L] | 1.0 | 1.0 |
| CAPRYLIC ACID [mL] | 0.1 | 0.1 |
| pH (NOMINAL) | 3.3 | 13.0 |

As shown in Table 2, the first eluent 1 was a sodium citrate buffer solution containing 13% by volume of ethanol as the organic solvent.

The detailed configuration and measurement condition of the amino acid analyzer 100 are shown in Table 3.

TABLE 3
MEASUREMENT METHOD

| SEPARATION COLUMN | CATION EXCHANGE RESIN | |
|---|---|---|
| | 4.6 mm I.D. × 60 mm | |
| REACTION REAGENT | NINHYDRIN COLORING SOLUTION | |
| | KIT FOR HITACHI | |
| REACTION TEMPERATURE | 135° | C. |
| DETECTION WAVELENGTH | VIS 440 nm, 570 nm | |
| SAMPLE INJECTION | 20 | μL |
| VOLUME | | |

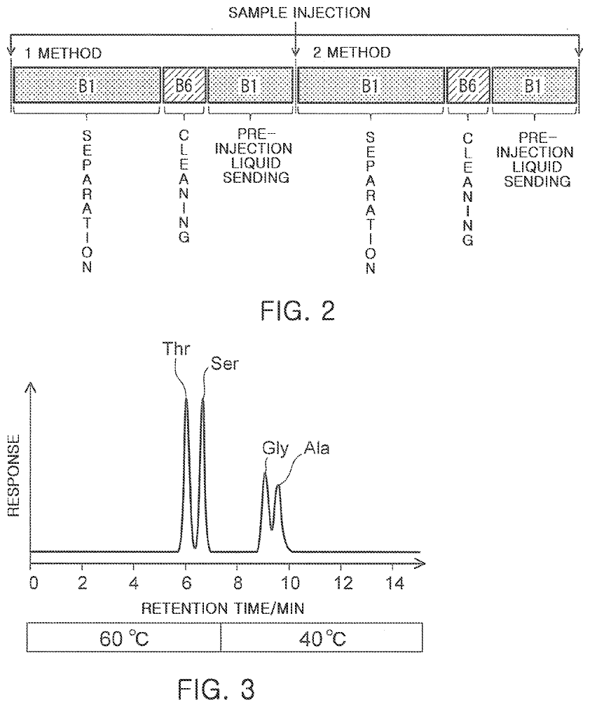

FIG. 2 is an example of the timetable on the time program of the amino acid analyzer 100. As illustrated in FIG. 2, when the autosampler 12 injects the sample into the flow path in the sample injection process, the separation process is started. In the separation process, the first eluent (B1 solution) is sent to the separation column 13. Then, the sample components are separated. When all the sample components to be analyzed are eluted and the separation process is completed, the cleaning process is started, the column regenerating solution 6 (B6 solution) is sent, and the separation column 13 is cleaned. When the cleaning process is completed, the pre-injection liquid sending process is started. The pre-injection liquid sending process is a process for sending, for example, the B1 solution to the separation column 13 before the sample injection process. This enables the separation column 13 to be stabilized before the sample injection.

In Example 1, in the separation process, the column temperature was set to the first temperature of 60° C. from the start of the separation process. Next, after the elution of threonine and serine is checked, the column temperature was decreased to the second temperature of 40° C.

FIG. 3 illustrates an example of the chromatogram of Example 1. As illustrated in FIG. 3, it was found that good separation performance was obtained for both the first group and the second group by setting the column temperature to the first temperature during the separation of the first group and decreasing the column temperature to the second temperature during the separation of the second group.

### Example 2

Analysis was performed under the same procedure and condition as in Example 1, except for the following configuration.

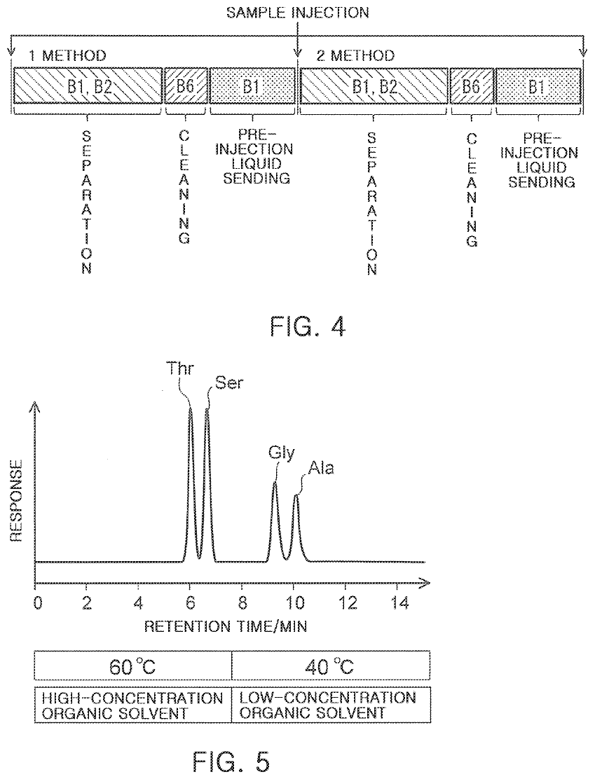

As illustrated in FIG. 4, in the separation process of Example 2, the first eluent 1 (B1 solution) and the second eluent 2 (B2 solution) might be sent to the separation column 13 by changing the mixing ratio thereof based on the gradient elution time program.

As the first eluent 1, a lithium citrate buffer solution was used in which “sodium citrate” in Table 2 was changed to “lithium citrate”. As the second eluent 2, a buffer solution was used in which the ethanol concentration of the first eluent 1 was 0% by volume.

In Example 2, in the separation process, in addition to control of the column temperature in Example 1, the first eluent 1 was sent from the start of the separation process to set the concentration of ethanol in the eluent to 13% by volume. Next, after the elution of threonine and serine is checked, the second eluent 2 was sent in place of the first eluent 1 to set the concentration of ethanol in the eluent to 0% by volume.

FIG. 5 illustrates an example of the chromatogram of Example 2. As illustrated in FIG. 5, it was found that the separation performance of the four components, especially the second group, was further improved by reducing the concentration of ethanol in the eluent during the separation of the second group, in addition to control of the column temperature.

### Example 3

Analysis was performed under the same procedure and condition as in Example 2, except for the following configuration.

The first temperature was set above 60° C. (approximately 80° C.), and the second temperature was set above 40° C. (approximately 60° C.). In addition, the flow rate of the eluent was increased from 0.40 mL/min by about 10% to 0.44 mL/min.

In Example 3, compared with Examples 1 and 2, the column temperature was increased as a whole. This reduces the viscosity of the eluent and suppresses the increase in pressure, which makes it possible to increase the flow rate.

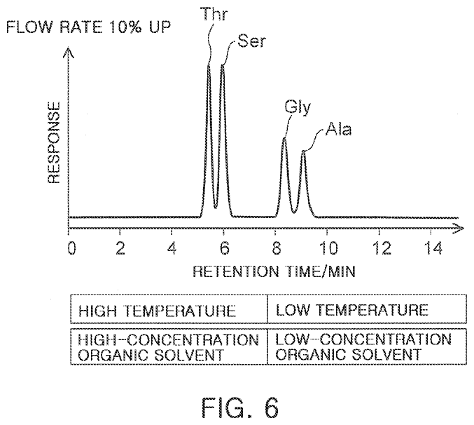

FIG. 6 illustrates an example of the chromatogram of Example 3. Comparing FIGS. 5 and 6, it can be seen that the retention time of the four components is shortened while the separation performance of the four components is maintained. That is, it was found that both high-separation and high-speed processing of analysis can be achieved by increasing the column temperature as a whole and increasing the flow rate to shorten the retention time of the four components while maintaining good separation performance in the first group and the second group.

### Comparative Example 1

Analysis was performed under the same procedure and condition as in Example 1, except that the column temperature was kept constant at 40° C.

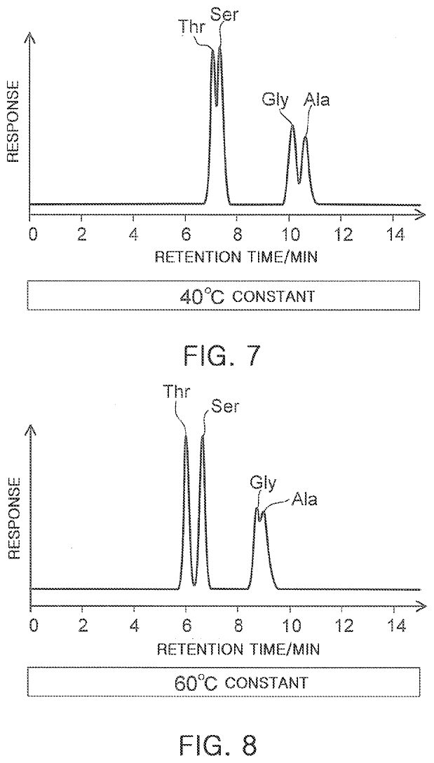

FIG. 7 illustrates an example of a chromatogram of Comparative Example 1. As illustrated in FIG. 7, when the column temperature was constant at 40° C., it was found that the peaks of threonine and serine in the first group overlapped so that sufficient separation performance could not be obtained.

### Comparative Example 2

Analysis was performed under the same procedure and condition as in Example 1, except that a column temperature was kept constant at 60° C.

FIG. 8 illustrates an example of a chromatogram of Comparative Example 2. As illustrated in FIG. 8, when the column temperature was constant at 60° C., it was found that the peaks of glycine and alanine in the second group overlapped so that sufficient separation performance could not be obtained.

### CONCLUSION

As is apparent from a comparison of FIGS. 3, 7, and 8, it can be seen that the first group is eluted before the second group, while the column temperature suitable for the separation of the first group is higher than the column temperature suitable for the separation of the second group. This is probably because the difference in retention time between threonine and serine increases at a higher column temperature, while the difference in retention time between glycine and alanine increases at a lower column temperature. As illustrated in FIG. 3, even when a single eluent is used, the separation performance of the four components is improved by setting the column temperature to the first temperature during the separation of the first group and decreasing the column temperature to the second temperature during the separation of the second group.

As illustrated in FIG. 5, decreasing the concentration of the organic solvent in the eluent during the separation of the second group, compared to that during the separation of the first group, is also effective in improving the separation performance.

In Examples 1 and 2, after the separation of the first group, since the column temperature is once decreased when the second group is separated, the analysis time required for separation of the second group may be extended. In this regard, as illustrated in FIG. 6, in Example 3, the flow rate of the eluent is increased by raising the overall column temperature. Therefore, even if it takes some time to separate the second group, it is possible to increase the speed of analysis as a whole while achieving high separation of analysis.

The present disclosure is not limited to the above examples, but includes various modifications. For example, the above examples have been described in detail to facilitate understanding of the present disclosure, and are not necessarily limited to those having all the configurations described. In addition, it is possible to replace part of the configuration of one example with the configuration of another example, and it is also possible to add the configuration of another example to the configuration of one example. Moreover, it is possible to add, delete, or replace another configuration with respect to part of the configuration of each example.

What is claimed is:

1. A method of analyzing amino acids using a liquid chromatographic apparatus equipped with a cation exchange column, comprising:
a process for distributing a sample containing threonine, serine, glycine, and alanine as the amino acids, together with an eluent, to the cation exchange column to separate threonine, serine, glycine, and alanine,
wherein column temperature when separating threonine and serine is higher than a column temperature when separating glycine and alanine.

2. The method according to claim 1, wherein;
threonine and serine have shorter retention times than glycine and alanine; and
glycine and alanine are eluted by decreasing column temperature after threonine and serine are eluted.

3. The method according to claim 1, wherein the eluent contains at least one selected from a group consisting of a sodium citrate buffer solution, a lithium citrate buffer solution, and a sodium sulfate aqueous solution.

4. The method according to claim 2, wherein the eluent contains at least one selected from a group consisting of a sodium citrate buffer solution, a lithium citrate buffer solution, and a sodium sulfate aqueous solution.

5. The method according to any one of claim 1, wherein;
the eluent contains an organic solvent; and
the organic solvent in the eluent when separating threonine and serine has a higher concentration than the organic solvent in the eluent when separating glycine and alanine.

6. The method according to any one of claim 2, wherein;
the eluent contains an organic solvent; and
the organic solvent in the eluent when separating threonine and serine has a higher concentration than the organic solvent in the eluent when separating glycine and alanine.

7. The method according to any one of claim 3, wherein;
the eluent contains an organic solvent; and
the organic solvent in the eluent when separating threonine and serine has a higher concentration than the organic solvent in the eluent when separating glycine and alanine.

8. The method according to any one of claim 4, wherein;
the eluent contains an organic solvent; and
the organic solvent in the eluent when separating threonine and serine has a higher concentration than the organic solvent in the eluent when separating glycine and alanine.

9. A liquid chromatographic apparatus comprising:
a liquid sending unit configured to send an eluent to a flow path;
a sample injection unit provided downstream of the liquid sending unit to inject a sample containing threonine, serine, glycine, and alanine into the eluent in the flow path;
a cation exchange column provided downstream of the sample injection unit to separate sample components in the sample;
a temperature regulating means for regulating column temperature of the cation exchange column; and
a control means for controlling the temperature regulating means,
wherein the control means controls the temperature regulating means such that column temperature when separating threonine and serine is higher than column temperature when separating glycine and alanine.

10. The liquid chromatographic apparatus according to claim 9, wherein;
threonine and serine have shorter retention times than glycine and alanine; and
the control means controls the temperature regulating means such that glycine and alanine are eluted by decreasing column temperature after threonine and serine are eluted.

11. The liquid chromatographic apparatus according to claim 9, wherein;
the eluent contains an organic solvent; and
the control means further controls the liquid sending unit such that the organic solvent in the eluent when separating threonine and serine has a higher concentration than the organic solvent in the eluent when separating glycine and alanine.

12. The liquid chromatographic apparatus according to claim 10, wherein;
the eluent contains an organic solvent; and
the control means further controls the liquid sending unit such that the organic solvent in the eluent when separating threonine and serine has a higher concentration than the organic solvent in the eluent when separating glycine and alanine.
